(19) United States
(12) Patent Application Publication
(10) Pub. No.: US 2020/0406913 A1
(43) Pub. Date: Dec. 31, 2020

(54) DECELERATION CONTROL DEVICE OF AUTOMATIC DRIVING VEHICLE

(71) Applicant: Toyota Jidosha Kabushiki Kaisha, Toyota-shi (JP)

(72) Inventors: Yuchi Yamanouchi, Toyota-shi (JP); Masaki Shitara, Nagakute-shi, (JP); Ryo Hattori, Kariya-shi (JP)

(21) Appl. No.: 16/911,731

(22) Filed: Jun. 25, 2020

(30) Foreign Application Priority Data
Jun. 28, 2019 (JP) 2019-121406

(51) Int. Cl. B60W 50/08; B60W 30/08; B60W 30/18; B60W 60/00

(52) U.S. Cl. CPC B60W 50/087; B60W 30/08; B60W 30/18109; B60W 2050/0005; B60W 2710/18; B60W 2710/20; B60W 60/001

(57) ABSTRACT

When an emergency stop switch is operated, a brake device brakes an automatic driving vehicle with a predetermined braking force after elapse of a predetermined time from a time at which the emergency stop switch is operated, based on a predetermined time and a predetermined braking force preset for a brake actuator. When a deceleration button is operated, the brake device brakes the automatic driving vehicle with the same braking force as the predetermined braking force after elapse of the same time as the predetermined time from a time at which the deceleration button is operated, based on a braking instruction from an ECU.

### CROSS REFERENCE TO RELATED APPLICATION

This application claims priority to Japanese Patent Application No. 2019-121406 filed on Jun. 28, 2019, which is incorporated herein by reference in its entirety including the specification, claims, drawings, and abstract.

### TECHNICAL FIELD

The specification discloses a deceleration control device of an automatic driving vehicle.

### BACKGROUND

In the related art, an automatic driving vehicle capable of automatic driving is known. Automatic driving means that a computer executes at least a part of driving control including vehicle speed control (including deceleration control), steering control, and the like.

In the related art, even during the automatic driving, since an operator in the automatic driving vehicle may perform deceleration control on the automatic driving vehicle, the automatic driving vehicle is provided with a deceleration switch so that the operator can perform the deceleration control during the automatic driving, in some cases.

For example, JP 2019-31284 A discloses an automatic driving vehicle including two buttons for decelerating and stopping the automatic driving vehicle during automatic driving, in which when one button is operated, a suitable place for stopping the automatic driving vehicle is first found, and deceleration is then started so as to stop the automatic driving vehicle at the found place, and when the other button is operated, deceleration is immediately started with a strong braking force and the automatic driving vehicle is stopped.

For example, as with the automatic driving vehicle disclosed in JP 2019-31284 A, in a case where the automatic driving vehicle is provided with a plurality of deceleration switches by which different braking forces are to be applied to the automatic driving vehicle, when it is necessary to promptly decelerate the automatic driving vehicle, the operator may instantaneously operate an improper deceleration switch. As used herein, the improper deceleration switch means a deceleration switch, by which the automatic driving vehicle is to be decelerated with smaller braking force, of the plurality of deceleration switches.

An object of a deceleration control device of an automatic driving vehicle disclosed in the specification is to prevent an operator from operating an improper deceleration switch when it is necessary to promptly decelerate the automatic driving vehicle during automatic driving, in the automatic driving vehicle including a plurality of deceleration switches for decelerating the automatic driving vehicle.

### SUMMARY

A deceleration control device of an automatic driving vehicle disclosed in the specification is a deceleration control device of an automatic driving vehicle capable of automatic driving, and includes a first deceleration switch and a second deceleration switch for decelerating the automatic driving vehicle during traveling in automatic driving, and a brake device that, when the first deceleration switch is operated, brakes the automatic driving vehicle with a predetermined braking force, and even when the second deceleration switch is operated, brakes the automatic driving vehicle with the same braking force as the predetermined braking force.

According to the above configuration, when the first deceleration switch is operated, and when the second deceleration switch is operated, the automatic driving vehicle is braked with the same braking force (predetermined braking force). Therefore, since neither of the first deceleration switch and the second deceleration switch can be an improper deceleration switch, it is possible to prevent an operator from operating an improper deceleration switch when it is necessary to promptly decelerate the automatic driving vehicle during the traveling in automatic driving.

When the first deceleration switch is operated, the brake device may brake the automatic driving vehicle after elapse of a predetermined time from a time at which the first deceleration switch is operated, and even when the second deceleration switch is operated, the brake device may brake the automatic driving vehicle after elapse of the same time as the predetermined time from a time at which the second deceleration switch is operated.

The deceleration control device may further include an ECU configured to perform driving control on the automatic driving vehicle including control on the brake device, the predetermined time and the predetermined braking force may be preset for the brake device, and when the first deceleration switch is operated, the ECU may stop the driving control and the brake device may brake the automatic driving vehicle, based on the preset predetermined time and predetermined braking force, and when the second deceleration switch is operated, the brake device may brake the automatic driving vehicle, based on a braking instruction from the ECU.

The first deceleration switch may be a mechanical switch, and the second deceleration switch may be a switch displayed on a touch panel.

The first deceleration switch may be an emergency stop switch configured to shut down at least one control device provided to the automatic driving vehicle.

According to the deceleration control device of the automatic driving vehicle disclosed in the specification, it is possible to prevent the operator from operating the improper deceleration switch when it is necessary to promptly decelerate the automatic driving vehicle during automatic driving, in the automatic driving vehicle including the plurality of deceleration switches for decelerating the automatic driving vehicle.

### BRIEF DESCRIPTION OF DRAWINGS

Embodiment(s) of the present disclosure will be described based on the following figures, wherein:

FIG. 1 depicts an outer appearance of an automatic driving vehicle according to an embodiment;

FIG. 2 is a functional block diagram of a deceleration control device according to the embodiment;

FIG. 3 depicts a screen of a touch panel during traveling in automatic driving; and

FIG. 4 is a flowchart depicting processing that is to be executed by the deceleration control device in accordance with the embodiment.

### DESCRIPTION OF EMBODIMENTS

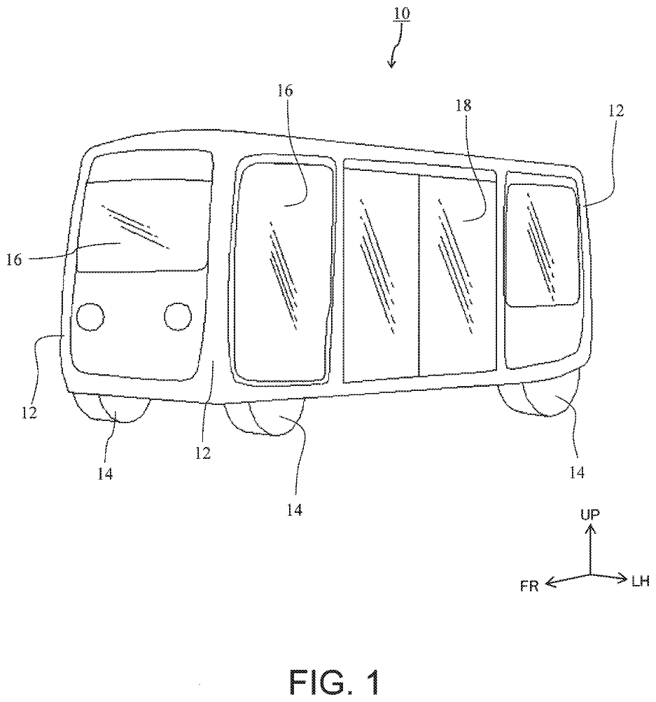

FIG. 1 depicts an outer appearance of an automatic driving vehicle 10 according to an embodiment. In the respective drawings of the specification, the terms “front (FR)” and “rear” mean the front and the rear in a front and rear direction of the vehicle, the terms “left (LH)” and “right” mean the left and the right when facing forward, and the terms “upper (UP)” and “lower” mean up and down in an upper and lower direction of the vehicle.

The automatic driving vehicle 10 has a substantially cuboid body, and has a symmetrical shape with respect to the front and rear direction, so that an outer appearance design is also symmetrical with respect to the front and rear direction. As seen from above, the automatic driving vehicle 10 is provided at its four corners with pillars 12 extending in the upper and lower direction, and wheels 14 are provided below the respective pillars 12. Front, rear, left, and right sidewalls of the automatic driving vehicle 10 are partially configured by transparent or translucent panels 16. The panel 16 may be configured as a display panel, on which characters and the like may be displayed.

A part of the panel 16 on the left side surface is configured as a slidable door 18, so that when the door 18 is slid and opened, passengers can get on and off. In the meantime, although not shown in FIG. 1, a slope is accommodated in a lower part of the door 18. The slope is used so as to get on and off a wheelchair, for example.

The automatic driving vehicle 10 is a van-type vehicle in which a number of unspecified passengers including an operator who controls the automatic driving vehicle 10 are to enter. In the embodiment, the automatic driving vehicle 10 is used as a bus that transports passengers while traveling along a prescribed route at a specific site. Therefore, it is assumed that the automatic driving vehicle 10 repeats stopping and starting at a relatively high frequency. Also, it is assumed that the automatic driving vehicle 10 travels at a relatively low speed (for example, 30 km/h or lower).

However, the use aspect of the automatic driving vehicle 10 disclosed in the specification can be appropriately changed. For example, the automatic driving vehicle 10 may be used as a movable business space or as a store such as a retail store in which diverse goods are displayed and sold, and a restaurant in which foods are cooked and provided. Also, the automatic driving vehicle 10 may be used as an office for business work, meetings with customers, and the like. Also, the usage scene of the automatic driving vehicle 10 is not limited to business. For example, the automatic driving vehicle 10 may be used as a personal moving means. Also, a traveling pattern of the automatic driving vehicle 10 may be appropriately changed.

The automatic driving vehicle 10 is an electric vehicle including, as a prime mover, a drive motor configured to receive power supply from a battery. The battery is a secondary battery that can be charged and discharged, and is periodically charged by external power. However, the automatic driving vehicle 10 is not limited to the electric vehicle and may be another type of a vehicle. For example, the automatic driving vehicle 10 may be an engine vehicle having an engine mounted thereon, as a prime mover, or may be a hybrid vehicle having an engine and a drive motor mounted thereon, as a prime mover. Also, the automatic driving vehicle 10 may be a hydrogen vehicle configured to drive a drive motor with power generated by fuel cells.

Also, the automatic driving vehicle 10 is a vehicle capable of automatic driving. Specifically, the automatic driving vehicle 10 can drive in a plurality of modes including an automatic driving mode, a semi-automatic driving mode, and a manual driving mode.

The automatic driving mode is a driving mode in which most of driving control is executed by a computer (ECU (which will be described later)) mounted on the automatic driving vehicle 10. In the specification, the driving control is a concept including gear change control, vehicle speed control, and steering control. Also, the vehicle speed control is a concept including start control, stop control, and acceleration/deceleration control of the automatic driving vehicle 10. The automatic driving vehicle 10 can perform communication with a management center for managing and controlling a plurality of automatic driving vehicles 10. In the automatic driving mode, the automatic driving vehicle 10 is configured to travel along a preset route under control of the management center. In the automatic driving mode, the driving control is performed by a computer, according to a driving instruction from the management center. However, the start control from a stop state is performed by an operation of the operator in the automatic driving vehicle 10. Also, although described in detail later, the operator can decelerate the automatic driving vehicle 10 during the automatic driving in the automatic driving mode.

The semi-automatic driving mode is a driving mode in which most of the driving control on the automatic driving vehicle 10 is executed by the ECU, like the automatic driving mode. In the semi-automatic driving mode, the ECU performs the driving control, based on detection results of various sensors (for example, a camera, a radar, and the like) provided to the automatic driving vehicle 10, regardless of the instruction from the management center. Also in the semi-automatic driving mode, the start control from the stop state is performed by an operation of the operator in the automatic driving vehicle 10. Also, the operator can decelerate the automatic driving vehicle 10 during the automatic driving in the semi-automatic driving mode.

The manual driving mode is a mode in which the automatic driving vehicle 10 does not perform the automatic driving and the operator in the automatic driving vehicle 10 performs the driving control on the automatic driving vehicle 10.

As described above, the automatic driving vehicle 10 travels along the prescribed route in the specific site. At this time, while traveling along the prescribed route, the automatic driving vehicle 10 basically travels in the automatic driving mode. While the automatic driving vehicle 10 moves from a standby place into the prescribed route or moves from the prescribed route to the standby place, for example, the semi-automatic driving mode and the manual driving mode are used.

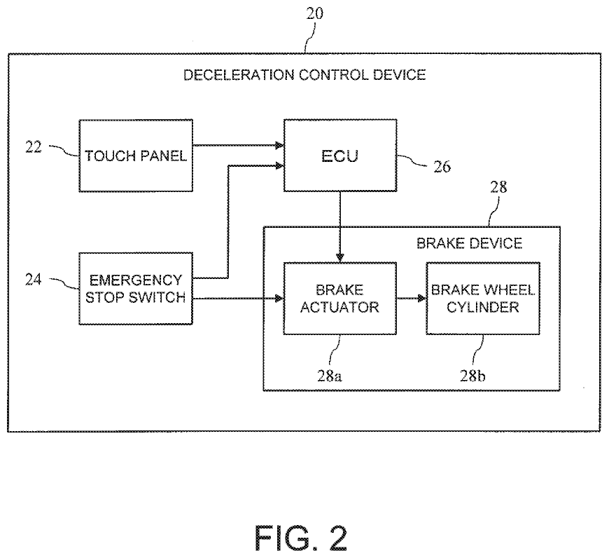

FIG. 2 is a functional block diagram of a deceleration control device 20 provided to the automatic driving vehicle 10. The deceleration control device 20 includes a touch panel 22, an emergency stop switch 24, an ECU (Electronic Control Unit) 26, and a brake device 28.

The touch panel 22 is provided in a vehicle interior of the automatic driving vehicle 10. The touch panel 22 may be provided in the vicinity of an operator seat for an operator so that the operator in the automatic driving vehicle 10 can favorably operate the same.

On the touch panel 22, a variety of buttons are displayed. The operator can input a control instruction to the automatic driving vehicle 10 by the buttons displayed on the touch panel 22. Specifically, the operator can input, to the automatic driving vehicle 10, driving control instructions, a driving mode change instruction, and control instructions on devices provided to the automatic driving vehicle 10 by the touch panel 22. Particularly, in the embodiment, regarding the driving control instructions, the operator can input, from the touch panel 22, a traveling start instruction to start the automatic driving vehicle 10 from the stop state and a deceleration instruction to decelerate the automatic driving vehicle 10 during traveling in the automatic driving.

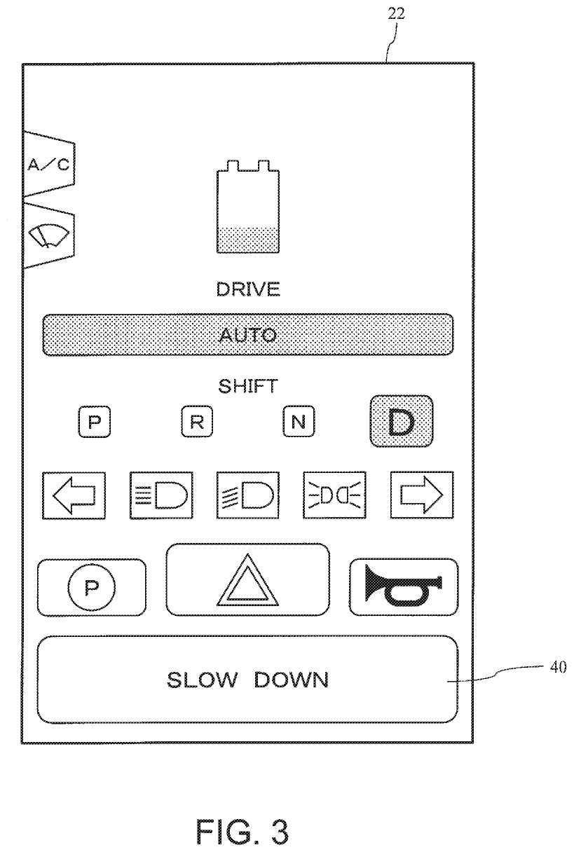

FIG. 3 depicts a screen of the touch panel 22 during traveling in the automatic driving. However, the traveling in the automatic driving includes not only a case in which the driving mode of the automatic driving vehicle 10 is the automatic driving mode and the automatic driving vehicle 10 travels in the automatic driving, but also a case in which the driving mode of the automatic driving vehicle 10 is the semi-automatic driving mode and the automatic driving vehicle 10 travels in the automatic driving. During the traveling in the automatic driving, a deceleration button 40 as a second deceleration switch for inputting a deceleration instruction to the automatic driving vehicle 10 is displayed on the touch panel 22. It is assumed that the deceleration button 40 is operated when it is necessary to temporarily decelerate or stop the automatic driving vehicle 10 while continuing to perform the automatic driving by the ECU 26, unlike the driving control by the ECU 26. When the automatic driving vehicle 10 is stopped, a start button for inputting a start instruction to the automatic driving vehicle 10 is displayed, instead of the deceleration button 40.

Meanwhile, on the touch panel 22, in addition to the deceleration button 40, there are also displayed a driving mode change button for inputting a driving mode change instruction, a gear change button for inputting a gear change control instruction, a P brake button for inputting an operation/release instruction for an electric parking brake, and a variety of device control buttons for inputting device control instructions to devices provided to the automatic driving vehicle 10.

Like the touch panel 22, the emergency stop switch 24 as a first deceleration switch is provided in the vehicle interior of the automatic driving vehicle 10. In the embodiment, the emergency stop switch 24 is configured as a mechanical switch such as a mechanical button, a toggle switch, a lever, or the like. As with the deceleration button 40 displayed on the touch panel 22, the emergency stop switch 24 is a switch for decelerating the automatic driving vehicle 10. Specifically, the operator can input an emergency stop instruction for decelerating and stopping the automatic driving vehicle 10 to the automatic driving vehicle 10 by the emergency stop switch 24. The emergency stop switch 24 is to shut down at least one control device provided to the automatic driving vehicle 10. Although described in detail later, in the embodiment, the ECU 26 is shut down by the emergency stop switch 24. It is assumed that the emergency stop switch 24 is operated when it is necessary to immediately decelerate and stop the automatic driving vehicle 10, such as a case in which an abnormal situation occurs in the automatic driving vehicle 10 or in the vicinity thereof.

Meanwhile, the deceleration control device 20 may include a mechanical operation part by which the operator inputs the driving control instruction, in addition to the touch panel 22 and the emergency stop switch 24. The mechanical operation part may be a stick-shaped operation part, which can be tilted in the front and rear direction and the right and left direction about a lower end as a support point, or a plurality of mechanical buttons, or the like, and is mainly used in the manual driving mode. Also, the automatic driving vehicle 10 is not provided with a foot pedal, which is operated so as to input a vehicle speed control instruction by a foot, such as an accelerator pedal or a brake pedal provided to a conventional vehicle and the like.

In this manner, the deceleration control device 20 includes the plurality of deceleration switches for decelerating the automatic driving vehicle 10. Meanwhile, in the embodiment, the first deceleration switch is the mechanical emergency stop switch 24, and the second deceleration switch is the deceleration button 40 displayed on the touch panel 22. However, both the first deceleration switch and the second deceleration switch may be mechanical switches or buttons displayed on the touch panel 22.

The ECU 26 is implemented in combination of hardware such as a microcomputer and software for operating the hardware. The ECU 26 is configured to perform the driving control of the automatic driving vehicle 10.

Specifically, when the driving mode of the automatic driving vehicle 10 is the automatic driving mode, the ECU 26 starts the traveling in the automatic driving, in response to a start instruction input from the touch panel 22, and thereafter performs the automatic driving according to a driving instruction received from the management center. The ECU 26 gives priority to a deceleration instruction input from the touch panel 22 over the driving instruction received from the management center even during the traveling in the automatic driving according to the driving instruction from the management center, and decelerates the automatic driving vehicle 10 according to the deceleration instruction.

When the driving mode of the automatic driving vehicle 10 is the semi-automatic driving mode, the ECU 26 starts the traveling in the automatic driving, in response to a start instruction input from the touch panel 22, and thereafter performs the automatic driving, based on detections results of the diverse sensors provided to the automatic driving vehicle 10. The ECU 26 gives priority to a deceleration instruction input from the touch panel 22 over the detections results of the diverse sensors even during the traveling in the automatic driving based on the detections results of the diverse sensors, and decelerates the automatic driving vehicle 10 according to the deceleration instruction.

When the driving mode of the automatic driving vehicle 10 is the manual driving mode, the ECU 26 starts the traveling in the automatic driving, in response to a start instruction input from the touch panel 22, and thereafter performs the driving control, based on a driving control instruction input from the mechanical operation part.

In addition, the ECU 26 changes the driving mode, in response to a driving mode change instruction input from the touch panel 22, and controls the device provided to the automatic driving vehicle 10, in response to a device control instruction input from the touch panel 22.

The brake device 28 includes a brake actuator 28a, and a brake wheel cylinder 28b attached to the wheel 14 (refer to FIG. 1) and configured to brake the wheel 14 (i.e., the automatic driving vehicle 10). The brake actuator 28a is an electric actuator, and is configured to regulate a hydraulic pressure in the brake wheel cylinder 28b, thereby adjusting a braking force to be applied to the wheel 14 by the brake wheel cylinder 28b. The brake actuator 28a is communicatively connected to the ECU 26, and can adjust the braking force of the brake wheel cylinder 28b, based on a braking instruction received from the ECU 26. Also, the brake actuator 28a is configured to receive an emergency stop instruction input from the emergency stop switch 24. However, as described later, the brake device 28 may have a structure other than the above-described structure so long as it can brake the automatic driving vehicle 10.

Hereinbelow, operations of the ECU 26 and the brake device 28, which are performed when the deceleration button 40 displayed on the touch panel 22 and the emergency stop switch 24 are operated, are described.

First, a case in which the emergency stop switch 24 is operated is described. When the operator operates the emergency stop switch 24, the emergency stop instruction is transmitted from the emergency stop switch 24 to the ECU 26 and the brake actuator 28a. When the emergency stop instruction is received, the ECU 26 immediately stops the driving control on the automatic driving vehicle 10. That is, the ECU 26 immediately stops the gear change control, the acceleration control, the steering control, and the like, in addition to the deceleration control, by transmitting the braking instruction to the brake actuator 28a. In the embodiment, when the emergency stop instruction is received, the ECU 26 shuts itself down to immediately stop all its operations.

For the brake actuator 28a, a predetermined time from a deceleration operation to braking start and a predetermined braking force are set in advance. For example, information indicative of the predetermined time and information indicative of a hydraulic pressure in the brake wheel cylinder 28b for braking the wheel 14 with the predetermined braking force are stored in advance in a storage unit (memory) provided to the brake actuator 28a. When the emergency stop instruction is received from the emergency stop switch 24, the brake actuator 28a adjusts the hydraulic pressure in the brake wheel cylinder 28b so that the wheel 14 is to be braked with the predetermined braking force after elapse of the predetermined time from a time at which the emergency stop instruction is received; i.e., a time at which the emergency stop switch 24 is operated, based on the preset predetermined time and predetermined braking force.

However, the predetermined braking force preset for the brake actuator 28a may be not only a constant braking force but also a braking force profile of which a plurality of braking forces are prescribed for a plurality of points of time after the braking start, so as to indicate the braking force to change over time. For example, the braking force profile may be such that the braking force is relatively high at the time of the braking start and thereafter decreases over time.

In the embodiment, the brake actuator 28a receives the emergency stop instruction from the emergency stop switch 24. However, the brake actuator 28a may be configured to detect stop of the driving control of the ECU 26, without receiving the emergency stop instruction from the emergency stop switch 24. In this case, the brake actuator 28a is configured to adjust the hydraulic pressure in the brake wheel cylinder 28b so that the wheel 14 is to be braked with the predetermined braking force after elapse of the predetermined time from a time at which the stop of the driving control of the ECU 26 is detected. As described above, the ECU 26 stops the driving control immediately after receiving the emergency stop instruction from the emergency stop switch 24. Therefore, also in this case, it can be said that the wheel 14 is braked with the predetermined braking force after elapse of the predetermined time from a time at which the emergency stop instruction is received.

Subsequently, a case in which the deceleration button 40 on the touch panel 22 is operated is described. When the operator operates (touches, in the embodiment) the deceleration button 40, a deceleration instruction is transmitted from the touch panel 22 to the ECU 26. When the deceleration instruction is received, the ECU 26 transmits, to the brake actuator 28a, a braking instruction for braking the wheel 14 with the same braking force as the predetermined braking force after elapse of the same time as the predetermined time from a time at which the deceleration button 40 is operated, based on the predetermined time and predetermined braking force preset for the brake actuator 28a. The brake actuator 28a adjusts the hydraulic pressure in the brake wheel cylinder 28b so that the wheel 14 is to be braked with the same braking force as the predetermined braking force after elapse of the same time as the predetermined time from the time at which the deceleration button 40 is operated, based on the braking instruction from the ECU 26.

While the operator continues to operate (touch, in the embodiment) the deceleration button 40, the ECU 26 commands the brake actuator 28a to keep braking the wheel 14, and the brake actuator 28a causes the brake wheel cylinder 28b to keep braking the wheel 14. When the operator releases the operation of the deceleration button 40 (detaches a finger or a stylus from the deceleration button 40, in the embodiment), the ECU 26 transmits a braking stop instruction to the brake actuator 28a, and the brake actuator 28a causes the brake wheel cylinder 28b to stop the braking of the wheel 14.

As described above, in the deceleration control device 20, when the emergency stop switch 24 is operated, the brake device 28 brakes the automatic driving vehicle 10 with the predetermined braking force after elapse of the predetermined time from the time at which the emergency stop switch 24 is operated, and when the deceleration button 40 is operated, the brake device 28 brakes the automatic driving vehicle 10 with the same braking force as the predetermined braking force after elapse of the same time as the predetermined time from the time at which the deceleration button 40 is operated. That is, when the emergency stop switch 24 is operated, and when the deceleration button 40 is operated, the automatic driving vehicle 10 is braked at the same braking start timing (a time period from the deceleration operation to the braking start) with the same braking force. That is, even when the operator operates either of the emergency stop switch 24 and the deceleration button 40, the automatic driving vehicle 10 is braked under the same conditions, so that neither of the emergency stop switch 24 and the deceleration button 40 can be an improper deceleration switch. Therefore, when it is necessary to promptly decelerate the automatic driving vehicle during the automatic driving, it is possible to prevent the operator from operating an improper deceleration switch.

In the meantime, the description “the braking start timing is the same (the time period from the deceleration operation to the braking start is the same) and the braking force is the same” does not mean that the time or the braking force is strictly the same, and rather means that, when the operator operates the emergency stop switch 24 and the deceleration button 40, the time or the braking force is the same to such a degree that the operator does not feel uncomfortable with respect to either operation feeling. Also, in the embodiment, when the emergency stop switch 24 is operated and when the deceleration button 40 is operated, the braking start timing and the braking force are the same, respectively. However, control of making only the braking force be the same may be performed, without performing control of matching the braking start timing.

As described above, it is assumed that the emergency stop switch 24 is operated when it is necessary to immediately decelerate or stop the automatic driving vehicle 10. Therefore, when the emergency stop switch 24 is operated, the automatic driving vehicle 10 is strongly braked by the brake device 28. That is, the predetermined braking force set for the brake actuator 28a is relatively high. Therefore, even when the deceleration button 40 is operated, the automatic driving vehicle 10 is similarly braked strongly.

However, during the traveling in the automatic driving, the gentle deceleration can be made by the driving control of the ECU 26, and when the operator operates the deceleration button 40, it can also be said that it is necessary to immediately decelerate or stop the automatic driving vehicle 10, in many cases. Also, as described above, it is assumed that the automatic driving vehicle 10 travels at a relatively low speed. For these reasons, when the deceleration button 40 is operated, it is considered that there are few problems even if the automatic driving vehicle 10 is braked as strongly as when the emergency stop switch 24 is operated.

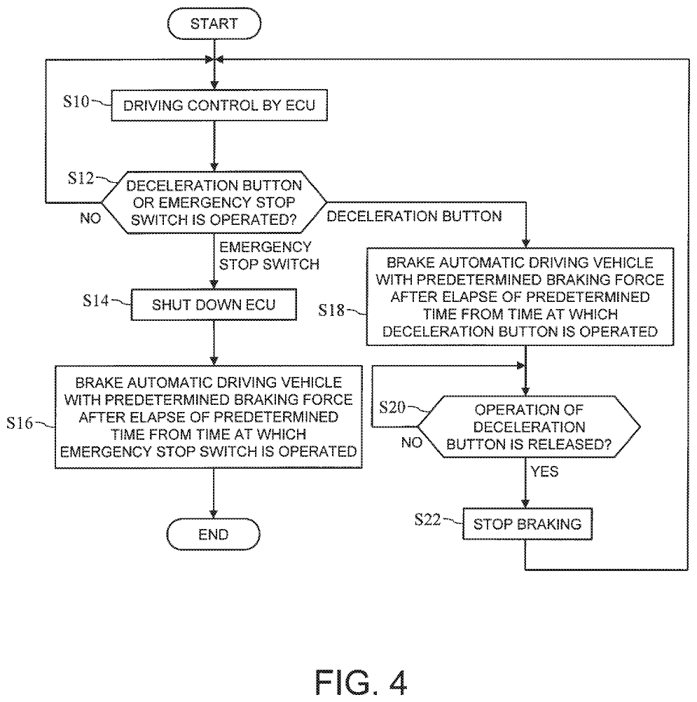

Below, processing of the deceleration control device 20 is described with reference to a flowchart shown in FIG. 4. At the start of the flowchart shown in FIG. 4, it is assumed that the automatic driving vehicle 10 is in the automatic driving mode or the semi-automatic driving mode and travels in automatic driving.

In step S10, the ECU 26 performs the automatic driving of the automatic driving vehicle 10, based on a driving instruction from the management center or detection results of the diverse sensors provided to the automatic driving vehicle 10.

In step S12, the ECU 26 determines whether the emergency stop switch 24 or the deceleration button 40 on the touch panel 22 is operated. When neither is operated, the ECU 26 returns to step S10 and continues to perform the driving control.

When it is determined that the emergency stop switch 24 is operated, in step S14, the ECU 26 shuts down itself, based on an emergency stop instruction from the emergency stop switch 24.

In step S16, the brake actuator 28a of the brake device 28 adjusts the hydraulic pressure in the brake wheel cylinder 28b so that the automatic driving vehicle 10 is to be braked with the predetermined braking force after elapse of the predetermined time from a time at which the emergency stop instruction is received from the emergency stop switch 24; i.e., after elapse of the predetermined time from a time at which the emergency stop switch 24 is operated, based on the preset predetermined time and predetermined braking force.

When it is determined that the emergency stop switch 24 is operated, the brake device 28 continues the braking until the automatic driving vehicle 10 stops. When the ECU 26 is resumed by the operator after the automatic driving vehicle 10 stops, the automatic driving vehicle 10 can resume the driving.

When it is determined in step S12 that the deceleration button 40 is operated, in step S18, the ECU 26 transmits, to the brake actuator 28a, a braking instruction for braking the automatic driving vehicle 10 with the predetermined braking force after elapse of the predetermined time from a time at which the deceleration button 40 is operated, based on the predetermined time and predetermined braking force preset for the brake actuator 28a. The brake actuator 28a adjusts the hydraulic pressure in the brake wheel cylinder 28b so that the wheel 14 is to be braked with the predetermined braking force after elapse of the predetermined time from the time at which the deceleration button 40 is operated, based on the braking instruction from the ECU 26.

In step S20, the ECU 26 determines whether the operation of the deceleration button 40 is released. When it is determined that the operation of the deceleration button 40 is not released, the ECU 26 commands the brake actuator 28a to keep braking the automatic driving vehicle 10, and the brake actuator 28a causes the brake wheel cylinder 28b to keep braking the automatic driving vehicle 10. When it is determined that the operation of the deceleration button 40 is released, in step S22, the ECU 26 transmits a braking stop instruction to the brake actuator 28a, and the brake actuator 28a causes the brake wheel cylinder 28b to stop the braking of the automatic driving vehicle 10. Thereafter, the ECU 26 returns to step S10 and continues to perform the driving control.

Although the embodiment of the deceleration control device of the automatic driving vehicle of the present disclosure has been described, the deceleration control device of the automatic driving vehicle of the present disclosure is not limited to the embodiment and can be diversely changed without departing from the gist thereof.

1. A deceleration control device of an automatic driving vehicle capable of automatic driving, the deceleration control device comprising:
a first deceleration switch and a second deceleration switch for decelerating the automatic driving vehicle during traveling in automatic driving; and
a brake device that, when the first deceleration switch is operated, brakes the automatic driving vehicle with a predetermined braking force, and even when the second deceleration switch is operated, brakes the automatic driving vehicle with the same braking force as the predetermined braking force.

2. The deceleration control device of an automatic driving vehicle according to claim 1, wherein when the first deceleration switch is operated, the brake device brakes the automatic driving vehicle after elapse of a predetermined time from a time at which the first deceleration switch is operated, and even when the second deceleration switch is operated, the brake device brakes the automatic driving vehicle after elapse of the same time as the predetermined time from a time at which the second deceleration switch is operated.

3. The deceleration control device of an automatic driving vehicle according to claim 2, further comprising an ECU configured to perform driving control of the automatic driving vehicle comprising control of the brake device,
wherein the predetermined time and the predetermined braking force are preset for the brake device, and
wherein when the first deceleration switch is operated, the ECU stops the driving control and the brake device brakes the automatic driving vehicle, based on the preset predetermined time and the preset predetermined braking force, and when the second deceleration switch is operated, the brake device brakes the automatic driving vehicle, based on a braking instruction from the ECU.

4. The deceleration control device of an automatic driving vehicle according to claim 1, wherein the first deceleration switch is a mechanical switch, and
wherein the second deceleration switch is a switch displayed on a touch panel.

5. The deceleration control device of an automatic driving vehicle according to claim 1, wherein the first deceleration switch is an emergency stop switch configured to shut down at least one control device provided to the automatic driving vehicle.
